(19) United States
(12) Patent Application Publication
(10) Pub. No.: US 2006/0225554 A1
(43) Pub. Date: Oct. 12, 2006

(54) Portable music editing system

(76) Inventor: Jerry L. Price JR., Chicago, IL (US)

Correspondence Address: WALLENSTEIN & WAGNER, LTD., 311 SOUTH WACKER DRIVE, 53RD FLOOR, CHICAGO, IL, 60606, US

(21) Appl. No.: 11/087,785

(22) Filed: Mar. 23, 2005

(51) Int. Cl. G10H 3/18

(52) U.S. Cl. 84/1

(57) ABSTRACT

A portable music editing system and apparatus is provided having a plurality of digital audio tracks stored in a memory, wherein each of the tracks is selectable for editing by the user through a plurality of editing functions. A recorder allows for the input of external audio data into the plurality of audio tracks. An output allows for the audio information stored in the tracks to be communicated through an audio output device. A power supply allows for the portability of the system and apparatus.

### TECHNICAL FIELD

The invention relates to a portable music editing system. More specifically, the invention is a portable, self-powered digital multi-track recorder for recording audio data in a plurality of digital audio tracks, modifying the stored data, and outputting the stored data to an output.

### BACKGROUND OF THE INVENTION

Sound editing devices take a variety of forms, including computer software for manipulating audio data stored in a computer memory and stand-alone hardware units for musicians. Such stand-alone units typically weigh between one and fifteen pounds, and are typically between one foot and three feet in width. They require a large desk space for their operation and also typically require an external power source such as a standard household electrical outlet.

In recent years, sound editing devices have been equipped with a digital memory for digitally storing audio data. Some devices also include an audio input for receiving analog audio signals and converting those signals to digital form. Other devices have an audio input port for receiving a transmission of digital audio data. Such devices require an external source of digital audio data to be connected to the audio input port.

Some editing devices allow a user to pause the output of audio data on one audio track and later play that track beginning from the paused position. That feature requires the user of the device to remember the precise position at which the track was paused, so as to be ready for the moment playback of the track begins. As an alternative, the user must rewind the track to allow for sufficient time to recognize the position of the track when the playback of the track reaches the paused position.

Some editing devices allow for a user to connect an output device such as a stereo speaker headset to the device. For audio input, however, those devices require the connection of a separate audio input device such as a microphone.

The present invention is provided to solve the problems discussed above and other problems and to provide advantages and aspects not provided by prior music editing systems of this type. A full discussion of the features and advantages of the present invention follows in the detailed description with reference to the accompanying drawings.

### SUMMARY OF THE INVENTION

The present invention is directed to a portable music editing system and apparatus. A plurality of digital audio tracks store digital audio information, wherein each of the tracks is selectable by the user through a user input apparatus. A recorder allows for the recording of audio data into a selected one of the plurality of digital audio tracks. An editor allows the user, via the user interface, to modify a portion of the audio data stored in or selected one of the plurality of digital audio tracks. An output allows for data from one of the plurality of digital audio tracks to be communicated to the user or to another device.

One aspect of the present invention is to provide a portable music editing apparatus that is light-weight and handheld, that requires neither significant space for usage or storage, nor an external power supply.

Another aspect of the present invention is to provide an internal source of audio data, such as data read from a compact disc via a built-in compact disc player into a digital memory. Stored audio information can also be written to a compact disc via the same device. Thus, edited audio using the present invention can be transported either via the apparatus itself or through a storage medium such as a compact disc.

A yet further aspect of the present invention is to provide a music editing apparatus that will play audio data from a paused audio track beginning at a point in the track prior to that at which the track was paused, so as to enable the user to ascertain without additional effort the portion of the track preceding the point at which the track was paused.

Another aspect of the present invention is to provide a music editing system that will accept a combination microphone/headset device as both an audio input and an audio output, so as to further compact and render portable the music editing device.

Other features and advantages of the invention will be apparent from the following specification taken in conjunction with the following drawings.

### BRIEF DESCRIPTION OF THE DRAWINGS

To understand the present invention, it will now be described by way of example, with reference to the accompanying drawings in which:

FIG. 1 is an illustration of the exterior of a portable music editing apparatus constructed in accordance with the principles of the present invention;

FIG. 2 is an block diagram of circuitry designed for use with the present invention; and,

FIG. 3 is an illustration of the exterior of a child-friendly portable music editing apparatus constructed in accordance with the principles of the present invention.

### DETAILED DESCRIPTION

While this invention is susceptible of embodiments in many different forms, there are shown in the drawings and described in detail preferred embodiments of the invention with the understanding that the present disclosure is to be considered as an exemplification of the principles of the invention and is not intended to limit the broad aspects of the invention to the embodiments illustrated.

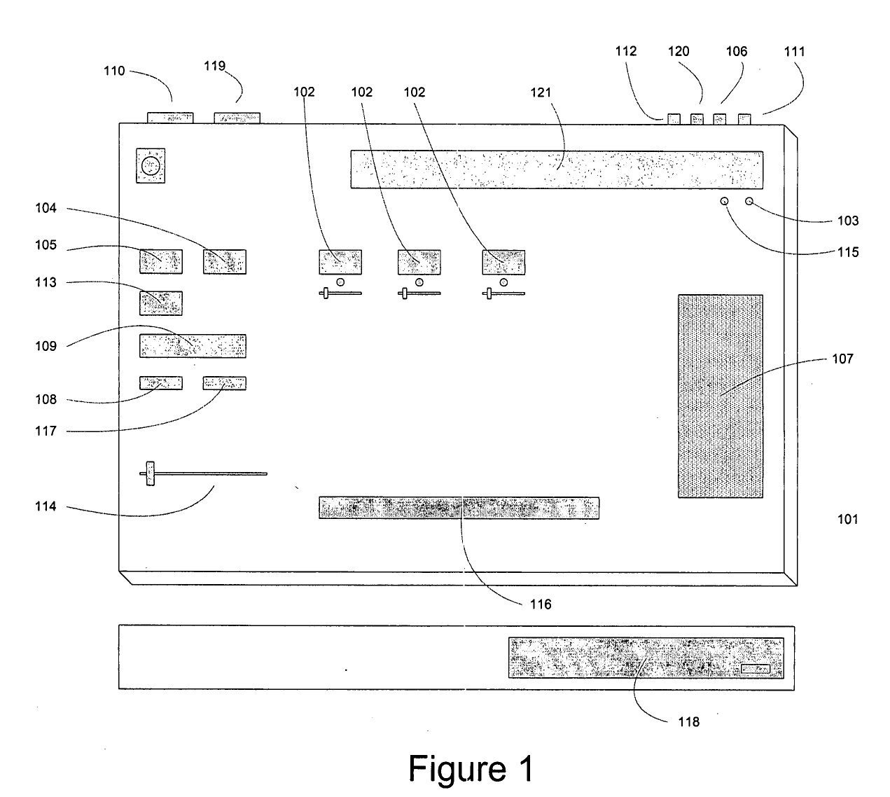

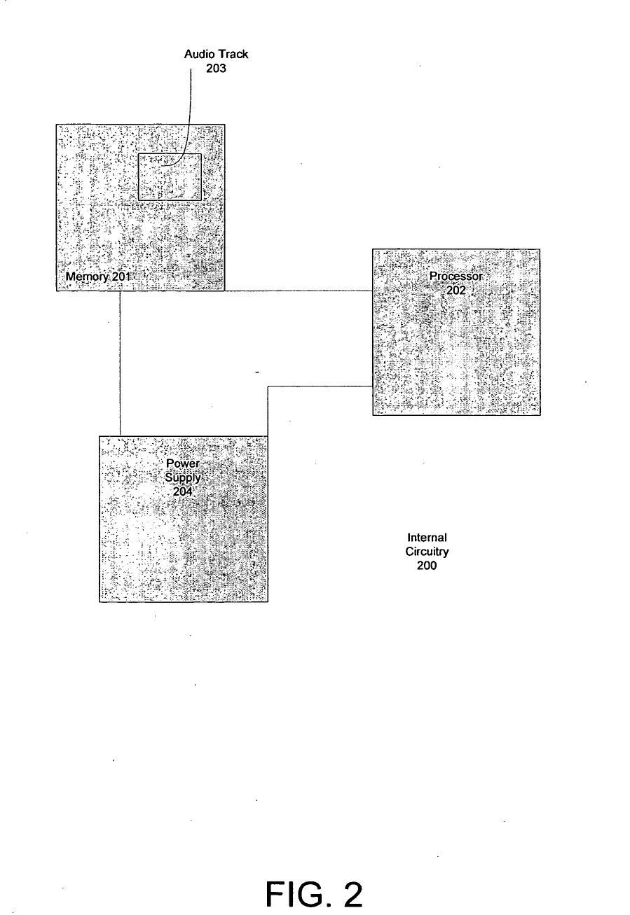

Referring initially to FIG. 1, a portable music editing apparatus 100 is provided in accordance with the principles of the present invention. Housing 101 is, in one embodiment, constructed of plastic such as durable polycarbonate. The portable music editing apparatus 100 is highly portable, measuring, in one embodiment, ten to twelve inches long by six to eight inches wide to one to two inches thick. Referring to FIG. 2, positioned within the interior of the housing 101 is digital recording circuitry 200, including non-volatile digital memory 201 and processor 202.

As illustrated in FIG. 2, memory 201 can be constructed of a variety of different types of non-volatile digital storage components, such as will be known to those of skill in the art. In a preferred embodiment, memory 201 is a standard 1024 megabyte power-off random access memory silicon chip, capable of indefinitely storing data of any variety. Specifically, memory 201 is for storing a plurality of digital audio tracks 203. Each audio track 203 has a dedicated space in memory 201, which is dynamically allocated so as to provide for the maximum utility of storage space in memory 201.

The data format of the digital audio tracks 203 can be of a variety of different types. In a preferred embodiment, the digital audio tracks 203 are stored in the .WAV format, providing for the a maximum degree of editing capability. In another embodiment, digital audio tracks 203 are stored in the compressed .MP3 format so as to provide for the maximum degree of storage capacity in memory 201.

The present invention provides a plurality of ways to populate the digital audio tracks 203 with digital audio data. First, microphone 111 may be used to record a user's voice or instrumentation into a selected audio track 203. Second, audio input port 106 may be used to receive audio information from an external source such as a compact disc player, a computer, or an electrical instrument such as a guitar or piano. Third, in one embodiment, compact disc player/recorder 118 is provided such that when a compact disc is inserted into the player/recorder 118, the user may select to copy of all of the digital audio tracks stored on the compact disc into digital audio tracks 203 stored in memory 201. When the user selects that alternative, the copying of the tracks from the compact disc to the memory 201 is accomplished such that there is a one-to-one correspondence between the compact disc audio tracks and the resulting stored tracks 203 in memory 201. In another embodiment, a fourth way of populating audio tracks 203 is provided via universal serial bus (USB) port 119. The user may connect a USB memory device, such as will be known to those of skill in the art, to the USB port 119. Data stored on the USB port can then be transferred to the memory 201, such that each audio file stored on the USB device is stored in a separate audio track 203 by processor 202.

Referring to FIG. 1, audio track selection buttons 102 are provided in connection with housing 101. In a preferred embodiment, each of the digital audio tracks 203 stored in memory 201 correspond to one track selection button 102. Upon startup, twelve audio tracks 203 are provided, each corresponding to a unique selection button 102. Alternatively or in addition, so as to save space on the face of housing 101, a single navigation button 103 is provided, so that the user may cycle through the audio tracks 203 through the use of a single button 103. The track selection buttons 102, 103, and all utility buttons embodying the present invention, are partly positioned within housing 101, so as to create an electrical connection with internal circuitry 200 when depressed. In another embodiment, selection buttons 102, 103, are entirely positioned within housing 101 so as to create a smooth face of housing 101. In that embodiment, selection buttons 102, 103 are heat sensitive and therefore do not require moving parts separate from the housing 101 and internal circuitry 200.

Using the selection button 102, 103, the user selects one of the plurality of digital audio tracks 203. Pressing play button 104 causes the selected digital audio track 203 to be called from memory 201 by processor 202. Referring to FIG. 2, processor 202 is an integrated circuit silicon chip programmed to perform the functions described herein, as will be appreciated by one of skill in the art. Processor 202 causes the selected audio track 203 to be recalled from memory 201 and transmitted to audio output 106, 107 is a speaker 107 positioned substantially or entirely within housing 101, depending on the selected method of constructing the apparatus 100. In another embodiment, audio output 106, 107 is an audio output port 106. Audio output port 106 can be any type of audio port capable of the transmission of audio data, including a standard quarter-inch or eighth-inch headphone port, or an RCA port. Additionally, as illustrated, multiple audio output ports 106 may be provided, and may be of either the same or different types.

In addition to the aforementioned speaker 107 and audio output port 106, the present invention is further equipped with other ways to communicate the audio data stored in the digital audio tracks 203. In a preferred embodiment, compact disc player/recorder 118 is provided to store the audio information from the audio tracks 203 to a writeable compact disc placed within the player/recorder 118. As illustrated in FIG. 2, when a writeable compact disc is placed within the player/recorder 118, the user may select to copy the audio tracks 203 stored in memory 201 to the compact disc. When that option is selected, the audio tracks 203 will be copied so as to create a one-to-one correspondence between the audio tracks 203 stored in memory 201 and the resulting audio tracks on the compact disc. In another embodiment, USB port 119 is provided to allow the user to copy the audio tracks 203 from the memory 201 onto an external USB storage device. When that option is selected, the processor 202 will copy the audio tracks 203 from the memory 201 through the USB port 119 such that each audio track 203 will be saves as a separate file on the external USB storage device.

When the selected audio track 203 is being played through the audio output 106, 107, the track will play to its conclusion or can be stopped by the user by pressing the stop button 105. The stop button 105 results in the stoppage of audio data transmission to audio output 106, 107, such that the last portion of the selected track 203 is not stored in memory 201. In other words, pressing play button 104 again will result in the selected track 203 playing from its start point in memory 201. In contrast, pressing pause button 108 results in the stoppage of audio data transmittal to audio output 106, 107, but the last portion played of the selected track 203 is saved in memory 201, such that pressing play button 104 results in the play of that selected track 203 from that stored position. In that way, the apparatus 100 functions similar to a digital music player.

Referring to FIG. 2, rechargeable power supply 204 is provided to enhance the portability of the apparatus 100. Power supply 204 provides electrical power to the internal circuitry 200 of the apparatus 100, and in a preferred embodiment, is a rechargeable lithium ion battery. However, rechargeable batteries of any variety may be used with the present invention, including NiMH batteries such as the Rayovac I-C rechargeable batteries. In one embodiment, the power supply 204 is entirely positioned and irremovable from within the housing 101. In that embodiment, power input 110 is used to electrically couple power supply 204 to a household electrical outlet for recharging the power supply 204. In another embodiment, power supply 204 is positioned within the housing 101, but is removable from the housing so as to be replaced by a separate power supply 204. In either of those embodiments, coupling an external power source to power input 110 recharges power supply 204 and also provides operating electrical current to internal circuitry 200.

While a digital audio track 203 has been selected by the user, pressing the edit button 109 indicates the user's desire to modify the audio information stored in the selected digital audio track 203. When the user enters the edit mode by pressing the edit button 109, a backup copy of the selected audio track 203 is automatically made, so as to enable a return to the pre-edit form of the selected audio track 203.

A plurality of different editing capabilities are provided by the present invention. First, and as illustrated in FIG. 1, the user can record ambient audio such as voice or instrument sound via the built-in microphone 111, which is positioned substantially inside the housing 101. The microphone 111 records audio sound, converts that analog sound to digital data, and stores that data as part of the selected digital audio track 203. In that way, the user's voice or instrumentation recorded by the microphone 111 becomes a part of the selected audio track 203. In another embodiment, the user can connect an external input source such as a compact disc player, external microphone, stereo system, computer, or electrically enabled instrument (e.g., guitar, electric piano) via audio input port 112. Data received through the audio input port 112 is added to the selected audio track 203 in the same manner as if recorded through microphone 111. Microphone 111 and audio input port 112 are not mutually exclusive; they may be used simultaneously to edit the audio data stored in audio track 203.

Second, the user may edit the audio data stored in audio track 203 by copying a portion of another audio track 203 and placing that copied portion into the selected audio track 203. Similarly, the user may select a portion of the selected audio track 203 and delete that portion. The user may also select the entirety of the select audio track 203 for deletion by pressing the erase button 113.

When adding information to the selected audio track 203, such as via the microphone 111 or audio input port 112, the user may select to pause the play of the selected track 203 by pressing the pause button 108. In the edit mode, pressing the pause button 108 does not have the same effect as when pressing the pause button 108 during the aforementioned play mode. In the edit mode, as in the play mode, pressing the pause button 108 causes the last played memory location of selected audio track 203 to be stored in memory 201. However, in the edit mode, pressing play button 104 does not result in the selected audio track 203 being played from the last played location. Instead, the location stored in the memory 201 is set to a memory location corresponding to an earlier portion of the selected audio track 203. It is common for musicians to manually rewind a selected track 203 to a point just prior to the musician's last edit point of the audio track 203. That technique allows the user to develop a sense of the background track (rhythm, tune, etc.), so that when the track reaches the point at which the user desires to continue editing, the user is familiar with the characteristics of the audio track 203. The present invention provides for that functionality without requiring the user to manually rewind the audio track 203 to a prior point. In a preferred embodiment, the memory 201 stores a memory address corresponding to a portion of the audio track 203 25 seconds prior to the point at which the audio track 203 was paused. Two selectable settings are provided so as to enable the user to select whether, in the edit mode, the pause button 108 will pause at the exact location of the audio track 203 last played, or at a point 25 seconds prior to the location of the audio track 203 last played. The user interface also allows the user to adjust the time period between the last played position of the audio track 203 and the position at which the track 203 will begin playing when the play button 104 is pressed. For example, if the user desires a period longer or shorter than the 25 second default, the user may set that time to be as desired.

The third editing capability provided by the present invention is an independent volume control. A volume control 114 is provided as part of the user interface of the apparatus 100, and that control 114 provides for controlling the “master” volume of the sound output from the apparatus 100. In the edit mode, however, a user can set an independent volume corresponding to each of the plurality of digital audio tracks 203. For instance, the user can use track selection buttons 102, 103 to select a first digital audio track 203. The user can then use the volume control 114 to set the volume of that first selected track 203 to be 50%. The user can save that volume information to the memory 201 by pressing save button 115. The user can then select a second selected audio track 203, and using volume control 114, can set the volume of that track to be 100%. Then, in the edit mode, both tracks can be played simultaneously into a third selected audio track 203, such that they are “mixed”. In the third, “mixed” track 203, the sound from both tracks will be combined, such that the volume of the second track 203 is 50% louder than the volume of the first track 203.

The fourth editing capability provided by the present invention is a plurality of selectable vocal effects. A vocal effect can be selected to modify existing audio data stored in a digital audio track 203, and can also be used to modify audio as it is input through either or both of microphone 111 or audio input port 106. In a preferred embodiment, three vocal effects are provided. The first is “telephone”, which modifies the audio data so as to create the effect as though the audio data were played through a standard telephone speaker the second is “computer”, which modifies the audio data so as to create a “computer-sounding”, monotone-style sound effect. The third is “echo”, which modifies the audio data so as to create an echo effect in the audio track 203. It will be understood that additional effects can be added to the present invention without departing from its principles. The processor 202 is programmed with logic to modify the data, such as will be appreciated by one of skill in the art.

When the user has completed the desired edits to the selected audio track 203, the user can select to render permanent those edits by pressing either the save button 115 or the convert button 116. That action by the user causes the backup copy of the selected audio track 203 (created when the edit button 109 was pressed) to be erased, rendering permanent the modifications to the data of the selected audio track 203. If, however, the user desires that the edits made to the audio track 203 be undone, the user may select the undo button 117. Pressing the undo button 117 causes the processor 202 to erase the data stored in the selected audio track 203, and replace that data with the backup copy stored in memory 201.

It will be appreciated by one of skill in the art that combination speaker/microphone headsets may be used as devices capable of both recording sound, through a boom microphone, and playing sound, through small speakers designed to be worn over the ears of the user. To further the portability of the present invention, the apparatus 100 is designed so as to be used with such combination speaker/microphone headsets. Audio input port 106 and audio output port 112, in one embodiment, are combined so as to enable a single input/output port 120 to serve as a connection to a combination microphone/speaker headset.

In a preferred embodiment, liquid crystal display screen 121 is provided to enable the user to view information regarding the selected audio track 203 and various editing options. The display screen 121 displays the number of the selected audio track 203, the location (in time) of the audio track 203, whether the apparatus 100 is in play mode or edit mode, and whether a vocal effect has been selected by the user. It will be appreciated by one of skill in the art that display screen 121 can be configured to display virtually any information regarding the function and performance of the apparatus 100. In another embodiment, display screen 121 is also touch-sensitive, so as to enable the dynamic generation of input buttons that are displayed on the display screen 121 and can be selected by the user.

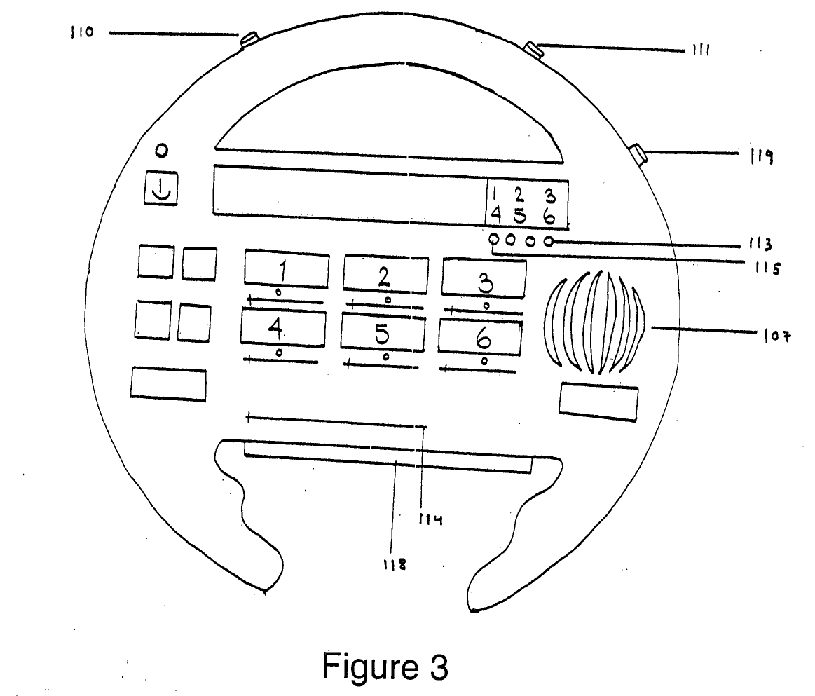

Referring to FIG. 3, apparatus 100 is shown in a child-friendly design and format.

While the specific embodiments have been illustrated and described, numerous modifications come to mind without significantly departing from the spirit of the invention, and the scope of protection is only limited by the scope of the accompanying claims.

What is claimed is:

1. A portable music editing system, comprising:
a plurality of digital audio tracks;
a selector for providing for selecting one of the plurality of digital audio tracks;
a recorder for recording audio data into the selected one of the plurality of digital audio tracks;
a memory for storing a backup copy of the audio data stored in the selected one of the plurality of digital audio tracks;
an editor for modifying the audio data stored in the selected one of the plurality of digital audio tracks;
an output for outputting the audio data stored in the selected one of the plurality of digital audio tracks; and,
a power supply providing electrical power to the portable music recording system.

2. The system of claim 1, further comprising:
an eraser for erasing the modified audio data stored in the selected one of the plurality of digital audio tracks and then storing the backup copy into the selected one of the plurality of digital audio tracks.

3. The system of claim 1, further comprising:
an optical storage component for writing the audio data stored in the selected one of the plurality of digital audio tracks to a compact disk.

4. The system of claim 1, wherein the editor provides for copying a portion of audio data from one of the plurality of digital audio tracks and adding the copied audio data to a different one of the plurality of digital audio tracks.

5. The system of claim 1, further comprising:
a pause component for stopping the output of audio data to the output component and storing a first memory location corresponding to the selected one of the plurality of digital audio tracks; and,
a playback component, wherein the playback component transfers, to the output component, audio data stored at a second memory location corresponding to the selected one of the plurality of digital audio tracks.

6. The system of claim 4, further comprising:
a second selector for selecting between two settings, wherein in the first setting, the first memory location and the second memory location are the same memory location, and wherein in the second setting, the first memory location and the second memory location are not the same memory location.

7. The system of claim 1, further comprising:
an independent volume control for assigning an output volume to each of the plurality of digital audio tracks, wherein the output volume of a first of the plurality of digital audio tracks is different from the output volume of a second of the plurality of digital audio tracks.

8. The system of claim 1, further comprising:
a second selector for selecting a quality mode for each of the plurality of digital audio tracks.

9. The system of claim 1, wherein the editor further comprises a plurality of selectable vocal effects for modifying the audio data stored in the selected one of the plurality of digital audio tracks.

10. The system of claim 1, further comprising:
a headset unit, wherein the recorder is a microphone operably connected to the headset unit, and further wherein the output is a speaker operably connected to the headset unit.

11. The system of claim 1, further comprising:
a reader for optically reading digital information from a compact disc and storing said digital information into the plurality of digital audio tracks.

12. A portable music editing apparatus, comprising:
a housing;
a non-volatile digital memory positioned within the housing;
a touch-sensitive liquid crystal display positioned substantially within the housing;
a rechargeable power supply positioned within the housing;
a recording apparatus;
an output;
a processor for executing a stored application; and,
a memory comprising logic for:
selecting one of a plurality of digital audio tracks;
recording audio data into the selected one of the plurality of digital audio tracks;
storing a backup copy of the audio data stored in the selected one of the plurality of digital audio tracks;
modifying the audio data stored in the selected one of the plurality of digital audio tracks; and,
outputting the audio data stored in the selected one of the plurality of digital audio tracks to the sound output.

13. The apparatus of claim 12, wherein the memory further comprises logic for erasing audio data stored in the selected one of the plurality of digital audio tracks and further comprises logic for storing the backup copy into the selected one of the plurality of digital audio tracks.

14. The apparatus of claim 12, further comprising:
an optical storage device positioned substantially within the housing.

15. The apparatus of claim 12, wherein the memory further comprises logic for copying a portion of audio data stored in one of the plurality of digital audio tracks and adding the copied portion of audio data to audio data stored in a different one of the plurality of digital audio tracks.

16. The apparatus of claim 12, wherein the memory further comprises logic for:
stopping the output of audio data to the output and storing a first memory location corresponding a selected one of the plurality of digital audio tracks; and,
outputting audio data stored at a second memory location corresponding to the selected one of the plurality of digital audio tracks.

17. The apparatus of claim 12, further comprising an independent volume control for assigning an output volume to each of the plurality of digital audio tracks, wherein the output volume of a first of the plurality of digital audio tracks is different from the output volume of a second of the plurality of digital audio tracks.

18. The apparatus of claim 12, further comprising a selector for selecting a quality mode for each of the plurality of digital audio tracks.

19. The apparatus of claim 12, wherein the memory further comprises logic for selecting from among a plurality of selectable vocal effects for modifying the audio data stored in the selected one of the plurality of digital audio tracks.

20. A portable music editing apparatus, comprising:
a housing;
a non-volatile digital memory positioned within the housing;
a touch-sensitive liquid crystal display positioned substantially within the housing;
a rechargeable power supply positioned within the housing;
a recording apparatus;
a sound output;
a processor for executing a stored application;
an optical storage device positioned substantially within the housing;
a memory for storing a plurality of digital audio tracks;
a reader positioned substantially within the housing for optically reading digital information from a compact disc and storing said digital information into the plurality of digital audio tracks;
an independent volume control for assigning an output volume to each of the plurality of digital audio tracks, wherein the output volume of a first of the plurality of digital audio tracks is different from the output volume of a second of the plurality of digital audio tracks;
an independent volume control for assigning an output volume to each of the plurality of digital audio tracks, wherein the output volume of a first of the plurality of digital audio tracks is different from the output volume of a second of the plurality of digital audio tracks, wherein the memory comprises logic for:
selecting one of a plurality of digital audio tracks;
recording audio data into the selected one of the plurality of digital audio tracks;
storing a backup copy of the audio data stored in the selected one of the plurality of digital audio tracks;
modifying the audio data stored in the selected one of the plurality of digital audio tracks;
outputting the audio data stored in the selected one of the plurality of digital audio tracks to the sound output;
erasing audio data stored in the selected one of the plurality of digital audio tracks and further comprises logic for storing the backup copy into the selected one of the plurality of digital audio tracks.
